(19) United States
(12) Patent Application Publication
(10) Pub. No.: US 2019/0089540 A1
(43) Pub. Date: Mar. 21, 2019

(54) DATA OBJECT TRANSFER BETWEEN NETWORK DOMAINS

(71) Applicant: Telefonaktiebolaget LM Ericsson (publ), Stockholm (SE)

(72) Inventors: Mikael Jaatinen, Raisio (FI); Jukka Ylitalo, Espoo (FI); Harri Hakala, Turku (FI); Ari Pietikäinen, Espoo (FI); Kennet Mattsson, Esbo (FI)

(21) Appl. No.: 16/083,069

(22) PCT Filed: Mar. 24, 2016
(86) PCT No.: PCT/SE2016/050246

§ 371 Date: Sep. 7, 2018

(51) Int. Cl. H04L 9/32; G06F 21/64; H04L 29/08

(52) U.S. Cl. CPC H04L 9/3247; G06F 21/64; H04L 2209/603; G06F 2221/2113; H04L 67/10

(57) ABSTRACT

There is provided mechanisms for handling transfer of a data object between network domains. A method is performed by a first data controller of a first network domain. The method comprises obtaining a request for transmission of the data object to a second data controller of a second network domain. The method comprises obtaining an identifier identifying allowable transfer of the data object between the first network domain and the second network domain. The method comprises providing a cryptographic integrity signature to the data object. The method comprises enabling transfer of the data object to the second network domain according to the identifier.

### TECHNICAL FIELD

Embodiments presented herein relate to data object handling, and particularly to methods, data controllers, computer programs, and a computer program product for handling transfer of a data object between network domains.

### BACKGROUND

In communications networks, there may be a challenge to obtain good performance and capacity for a given communications protocol, its parameters and the physical environment in which the communications network is deployed.

For example, in communications networks, where data potentially can move between network domains, there is a need to monitor and track, and optionally to restrict, some specific data objects from moving from one network domain to another or to render the data object in such a manner that requirements of the network domain to which the data objects belong are fulfilled.

The requirements for limiting movement of data objects between network domains are relatively new, and technologies supporting such requirements are limited.

Existing technology centers on either digital rights management (DRM), where one aim is to control what entity is allowed access to the data objects and in which terms, or data leakage protection (DLP), where one aim is to control that sensitive data objects are not disclosed to unauthorized parties.

U.S. Pat. No. 5,664,017A defines a method for one to one cryptographic communications with national sovereignty. The method is based encrypted message which is controlled by keys, but fails to provide a method to control what information is allowed send across jurisdiction areas.

Hence, there is still a need for an improved handling data objects in networks having at least two network domains.

### SUMMARY

An object of embodiments herein is to provide efficient handling of data objects between network domains.

According to a first aspect there is presented a method for handling transfer of a data object between network domains. The method is performed by a first data controller of a first network domain. The method comprises obtaining a request for transmission of the data object to a second data controller of a second network domain. The method comprises obtaining an identifier identifying allowable transfer of the data object between the first network domain and the second network domain. The method comprises providing a cryptographic integrity signature to the data object. The method comprises enabling transfer of the data object to the second network domain according to the identifier.

According to a second aspect there is presented a data controller of a first network domain for handling transfer of a data object between network domains. The data controller comprises processing circuitry. The processing circuitry is configured to cause the data controller to obtain a request for transmission of the data object to another data controller of a second network domain. The processing circuitry is configured to cause the data controller to obtain an identifier identifying allowable transfer of the data object between the first network domain and the second network domain. The processing circuitry is configured to cause the data controller to provide a cryptographic integrity signature to the data object. The processing circuitry is configured to cause the data controller to enable transfer of the data object to the second network domain according to the identifier.

According to a third aspect there is presented a data controller of a first network domain for handling transfer of a data object between network domains. The data controller comprises processing circuitry and a computer program product. The computer program product stores instructions that, when executed by the processing circuitry, causes the data controller to perform a number of operations, or steps. The operations, or steps, involve the data controller to obtain a request for transmission of the data object to another data controller of a second network domain. The operations, or steps, involve the data controller to obtain an identifier identifying allowable transfer of the data object between the first network domain and the second network domain. The operations, or steps, involve the data controller to provide a cryptographic integrity signature to the data object. The operations, or steps, involve the data controller to enable transfer of the data object to in the second network domain according to the identifier.

According to a fourth aspect there is presented a data controller of a first network domain for handling transfer of a data object between network domains. The data controller comprises an obtain module configured to obtain a request for transmission of the data object to another data controller of a second network domain. The data controller comprises an obtain module configured to obtain an identifier identifying allowable transfer of the data object between the first network domain and the second network domain. The data controller comprises a provide module configured to provide a cryptographic integrity signature to the data object. The data controller comprises an enable module configured to enable transfer of the data object to the second network domain according to the identifier.

According to a fifth aspect there is presented a computer program for handling transfer of a data object between network domains, the computer program comprising computer program code which, when run on processing circuitry of a data controller of a first network domain, causes the data controller to perform a method according to the first aspect.

According to a sixth aspect there is presented a method for handling transfer of a data object between network domains. The method is performed by a second data controller of a second network domain. The method comprises obtaining the data object from a first data controller of a first network domain. The data object is provided with a cryptographic integrity signature of the first data controller. The method comprises obtaining an identifier identifying allowable handling of the data object in the second network domain.

According to a seventh aspect there is presented a data controller of a second network domain for handling transfer of a data object between network domains. The data controller comprises processing circuitry. The processing circuitry is configured to cause the data controller to obtain the data object from a first data controller of a first network domain. The data object is provided with a cryptographic integrity signature of the first data controller. The processing circuitry is configured to cause the data controller to obtain an identifier identifying allowable handling of the data object in the second network domain.

According to an eighth aspect there is presented a data controller of a second network domain for handling transfer of a data object between network domains. The data controller comprises processing circuitry and a computer program product. The computer program product stores instructions that, when executed by the processing circuitry causes the data controller to obtain the data object from a first data controller of a first network domain. The data object is provided with a cryptographic integrity signature of the first data controller. The computer program product stores instructions that, when executed by the processing circuitry causes the data controller to obtain an identifier identifying allowable handling of the data object in the second network domain.

According to a ninth aspect there is presented a data controller of a second network domain for handling transfer of a data object between network domains. The data controller comprises an obtain module configured to obtain the data object from a first data controller of a first network domain. The data object is provided with a cryptographic integrity signature of the first data controller. The data controller comprises an obtain module configured to obtain an identifier identifying allowable handling of the data object in the second network domain.

According to a tenth aspect there is presented a computer program for handling transfer of a data object between network domains, the computer program comprising computer program code which, when run on processing circuitry of a data controller of a second network domain, causes the data controller to perform a method according to the sixth aspect.

According to an eleventh aspect there is presented a computer program product comprising a computer program according to at least one of the fifth aspect and the tenth aspect and a computer readable storage medium on which the computer program is stored. The computer readable storage medium can be a non-transitory computer readable storage medium.

Advantageously these methods, these data controllers, and these computer programs provide efficient transfer of data objects between network domains.

Advantageously these methods, these data controllers, and these computer programs provide efficient monitoring of movements of data objects between network domains.

Advantageously these methods, these data controllers, and these computer programs provide efficient control of movements of data objects between network domains.

Advantageously these methods, these data controllers, and these computer programs provide the possibility to assess the network domain to which the data object is bound, without revealing the information content of the data object.

Advantageously these methods, these data controllers, and these computer programs provide the possibility to define multi level security controls on data transfer between network domains.

Advantageously these methods, these data controllers, and these computer programs provide augmented tagging of information contained in data objects, e.g. with a KSI signature, that can be included as an integral part of the data object or as part of metadata associated with the data object

It is to be noted that any feature of the first, second, third, fourth, fifth, sixth seventh, eight, ninth, tenth and eleventh aspects may be applied to any other aspect, wherever appropriate. Likewise, any advantage of the first aspect may equally apply to the second, third, fourth, fifth, sixth, seventh, eight, ninth, tenth, and/or eleventh aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 2, 3, and 4 are schematic diagrams illustrating communications networks comprising network domains according to embodiments;

FIGS. 5, 6, 7, and 8 are flowcharts of methods according to embodiments;

FIG. 9a is a schematic diagram showing functional units of a data controller according to an embodiment;

FIG. 9b is a schematic diagram showing functional modules of a data controller according to an embodiment; and

FIG. 10 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

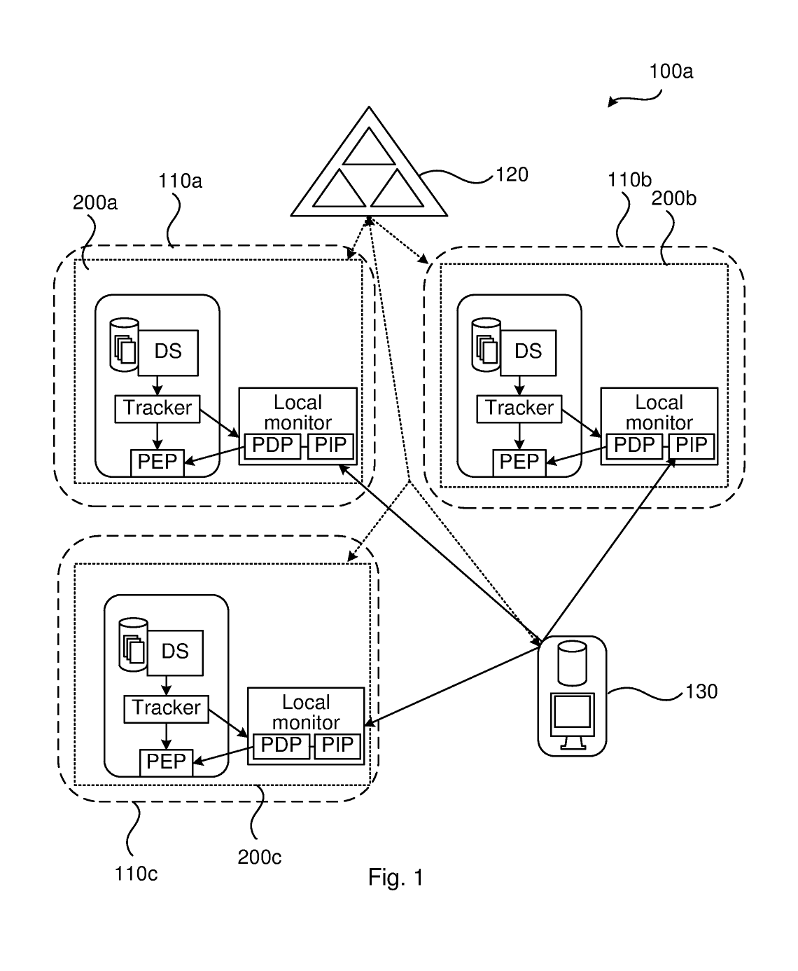

Reference is now made to FIG. 1. FIG. 1 is a schematic diagram illustrating a communications network 100a where embodiments presented herein can be applied. The communications network 100a comprises network domains 110a, 110b, 110c. Each network domain 110a. 110b, 110c comprises a data controller 200a, 200b, 200c. Details of the data controllers 200a, 200b, 200c will be provided below.

The communications network 100a further comprises a Keyless Signature Infrastructure (KSI) 120. In general terms, KSI is a globally distributed system for providing timestamping and integrity verification service. KSI uses only hash-function cryptography, allowing verification to rely only on the security of hash-functions and the availability of a public ledger commonly referred to as a blockchain. The communications network 100a further comprises a central repository 130. The central repository 130 acts as global network rule-set instant and comprises policy rules of the network domains 110a, 110b, 110c. The policy rules define allowed and disallowed transfers of data objects between the network domains 110a, 110b, 110c. The policy rules can further define controls relating to delay of transfer of data objects between the network domains 110a, 110b, 110c until a defined grace period has been passed, and/or allow transfer of data objects if the age of the data object has passed a predefined length in time. By means of the central repository 130 the global network rule-set is distributed to policy information points (see below) in the data controllers 200a, 200b 200c.

A data object refers to a defined piece of data which is subject to restrictions to transfer between specific network domains 110a, 110b, 110c.

A data controller 200a, 200b, 200c refers to a device which is configured to, either by itself or jointly with at least one other data controller, determine the purposes and means of processing of the data object.

A network domain 110a, 110b, 110c of a given data controller 200a, 200b, 200c refers to a part of a network 100a over which authority of that given data controller extends.

Data sovereignty relates to the concept of information that has been converted and stored in binary digital form as a data object, where the data object is subject to the rules of the network domain in which it is located, or where applicable, subject to governance restrictions related to the location of the data object within the network domain.

A location tag refers to information indicating in which network domain the data object has been handled.

A domain signature refers to a unique identifier that binds the location tag to the data object.

A cryptographic integrity signature refers to a unique identifier making it possible to attesting the domain signature in a non-reputable manner.

A digital signature (DS) module refers to an entity that verifies the integrity of the data object by using the KSI 120.

Monitoring referring to actions performed by a local monitor module to supervise that, based on notification information, a data object which is subject to a specific network domain is not to be transferred from that specific network domain to another network domain.

A policy information point (PIP) module, as provided in the local monitor module, receives from the tracker module an indication of intended transfer of the data object and analyses whether the transfer is to occur between network domains and then passes this information to an enforcer module. Each policy information point comprises a local rule base for allowed and disallowed transfers of data objects between network domains.

A policy decision point (PDP) module, as provided in the local monitor module, decides, based on information received from the policy information point whether transfer of the data object is allowed or disallowed.

A policy enforcement point (PEP) module, as provided by an enforcer module, is located in each network domain and, based on input from a policy decision point, inserts the domain signature and verifies the integrity of the domain signature.

Tracking refers to actions, as performed by a tracker module, for keeping track of data objects subject to restrictions of transfer out from a given network domain and for notifying a monitoring system when the data object is transferred from the given network domain. A tracker module is located at each network domain boundary that the data object can cross. The tracker module indicates to the local monitor module, based on a database of connection points, from where to where the data object is about to move and associates the data object with a location tag.

Data leakage (or loss) prevention (DLP) refers to a technical system configured to detect and/or prevent the transmission of a data object to and/or from a given network domain, either while in use, in transit, or at rest. Digital rights management (DRM) refers to a technical system configured to restrict the usage, transfer, and/or modification of proprietary or copyright-protected data objects. Both DRM and DLP fails to provide monitoring, controlling and transparently assessing the network domain-wise location and other metadata of the data object.

The embodiments disclosed herein therefore relate to mechanisms for handling transfer of a data object between network domains 110a, 110b, 110c. In order to obtain such mechanisms there is provided a data controller 200a of the first network domain 110a, a method performed by the data controller 200a of the first network domain 110a, a computer program product comprising code, for example in the form of a computer program, that when run on processing circuitry of the data controller 200a of the first network domain 110a, causes the data controller 200a of the first network domain 110a to perform the method. In order to obtain such mechanisms there is further provided a data controller 200b, 200c of the second network domain 110b, 110c, a method performed by the data controller 200b, 200c of the second network domain 110b, 110c, and a computer program product comprising code, for example in the form of a computer program, that when run on processing circuitry of the data controller 200b, 200c of the second network domain 110b, 110c, causes the data controller 200b, 200c of the second network domain 110b, 110c to perform the method.

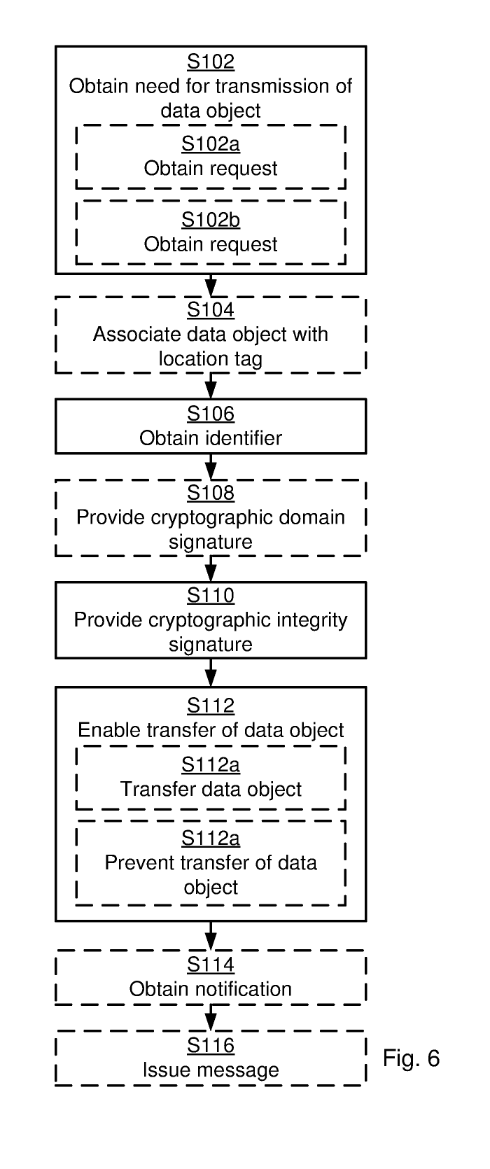

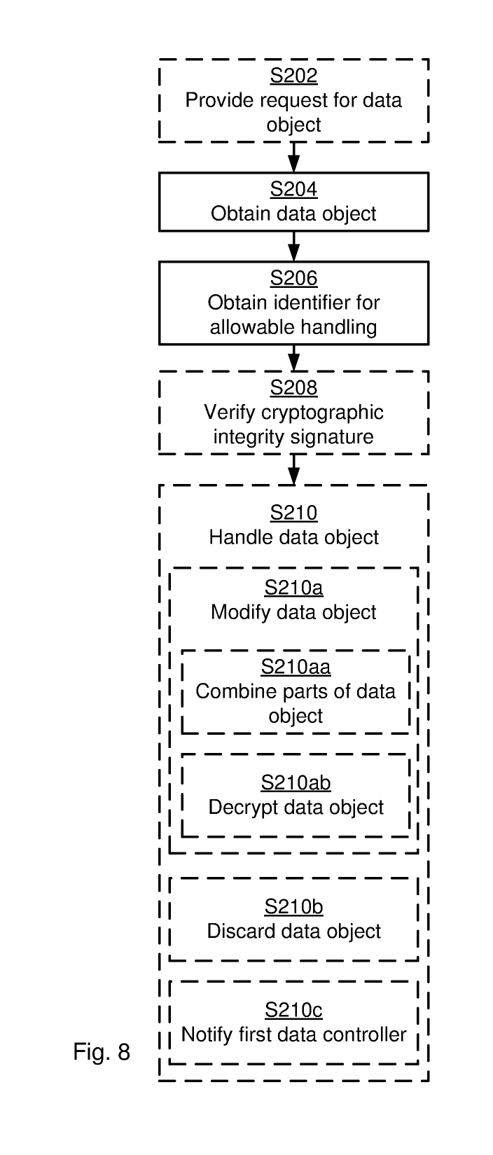

FIGS. 5 and 6 are flow charts illustrating embodiments of methods for handling transfer of a data object between network domains 110a, 110b, 110c as performed by the data controller 200a of the first network domain 110a. FIGS. 7 and 8 are flow charts illustrating embodiments of methods for handling transfer of a data object between network domains 110a, 110b, 110c as performed by the data controller 200b, 200c of the second network domain 110b, 110c. The methods are advantageously provided as computer programs 420a, 420b.

Reference is now made to FIG. 5 illustrating a method for handling transfer of a data object between network domains 110a, 110b, 110c as performed by the data controller 200a of the first network domain 110a according to an embodiment. The data controller 200a will therefore be denoted a first data controller 200a (whereas the data controller 200b, 200c of the second network domain 110b, 110c will be denoted a second data controller 200b, 200c).

S102: The first data controller 200a obtains a request for transmission of the data object to the second data controller 200b, 200c of the second network domain 110b, 110c. Different examples of such requests will be disclosed below.

Before making the data object available to the second data controller 200b, 200c the first data controller 200a checks what kind of transfer of the data object is allowed and therefore performs step S106:

S106: The first data controller 200a obtains an identifier identifying allowable transfer of the data object between the first network domain 110a and the second network domain 110b, 110c.

Upon having obtained the identifier the first data controller 200a signs the data object, as in step S110:

S110: The first data controller 200a provides a cryptographic integrity signature to the data object.

Transfer of the data object is then enabled by the first data controller 200a performing step S112:

S112: The first data controller 200a enables transfer of the data object to the second network domain 110b, 110c according to the identifier.

There could be different ways for the first data controller 200a to obtain the identifier identifying allowable transfer of the data object between the first network domain 110a and the second network domain 110b, 110. According to an embodiment the identifier is obtained from a local rule base in the first network domain 110a. One example of such a local rule base is the PIP module. In turn the PIP module of the first data controller 200a may retrieve the identifier from the central repository 130.

According to an embodiment the data object is further provided with the identifier, and the identifier could further identify allowable handling of the data object in the second network domain 110b, 110c. The identifier could then be provided with the cryptographic integrity signature.

There could be different ways to provide the cryptographic integrity signature. According to an embodiment the cryptographic integrity signature is based on integrity protection or a block chain technology such as a keyless signature infrastructure (KSI).

Reference is now made to FIG. 6 illustrating methods for handling transfer of a data object between network domains 110a, 110b, 110c as performed by the data controller 200a of the first network domain 110a according to further embodiments. Steps S102, S106, S110, and S112 are performed as with reference to FIG. 5 and a repeated description thereof is therefore omitted.

There may be different ways for the first data controller 200a to obtain the request in step S102. Different embodiments relating thereto will now be described in turn.

According to a first embodiment the request is obtained from the second data controller 200b, 200c. Hence, according to this embodiment the first data controller 200a is configured to obtain the request for transmission of the data object to the second data controller 200b, 200c by performing step S102a:

S102a: The first data controller 200a obtains a request from the second data controller 200b, 200c for transmission of the data object to the second network domain 110b, 110c.

According to a second embodiment the request is obtained from a local send function in the first network domain 110a. Hence, according to this embodiment the first data controller 200a is configured to obtain the request for transmission of the data object to the second data controller 200b, 200c by performing step S102b:

S102b: The first data controller 200a obtains a request from a local send function of the first data controller 200a for transmission of the data object to the second network domain 110b, 110c.

There may be different ways for the first data controller 200a to process the data object before enabling transfer of the data object to the second network domain 110b, 110c. According to an embodiment the first data controller 200a associates the data object with a location tag and provides a cryptographic domain signature by performing steps S104 and S108:

S104: The first data controller 200a associates the data object with a location tag. The location tag identifies the first network domain 110a.

S108: The first data controller 200a provides, based on the identifier (as obtained in step s106), a cryptographic domain signature that binds the location tag to the data object.

According to an embodiment step S104 is thus performed between step S102 and step s106, and step S108 is performed between step S106 and step S110.

There may be different types of allowable transfer of the data object. Different embodiments relating thereto will now be described in turn.

According to an embodiment the allowable transfer comprises preventing transfer of the data object to the second network domain 110b, 110c, allowing transfer of the data object to the second network domain 110b, 110c, preventing modification of the data object in the second network domain 110b, 110c transfer, allowing modification of the data object in the second network domain 110b, 110c, requiring modification of the data object in the first network domain 110a prior to transfer of the data object to the second network domain 110b, 110c, or any combination thereof.

The allowable transfer may be associated with allowable handling of the data object in terms of modifications performed in the second network domain 110b, 110c. According to a further embodiment modification of the data object thus comprises combining at least a first data object part and a second object part into the data object, decrypting the data object in the second network domain 110b, 110c, or any combination thereof.

The allowable transfer of the data object can relate to modifications required at the first data controller 200a prior to transfer of the data object to the second network domain 110b, 110c. According to a further embodiment the allowable transfer thus requires the data object to be modified prior to transfer of the data object to the second network domain 110b, 110c.

There could be different examples of required modifications that need to be performed at the first data controller 200a prior to transfer of the data object to the second network domain 110b, 110c. According to a further embodiment the allowable handling requires the data object to be split into at least a first data object part and a second object part, encrypted, anonymized, pseudonymized, prior to transfer of the data object to the second network domain 110b, 110c, or any combination thereof. In more detail, the data object may be split into at least the first data object part and the second object part to be received by separate receivers in the second network domain 110b, 110c, such that no single receiver in the second network domain 110b, 110c obtains all the parts of the thus split data object, or that one second network domain 110b and another second network domain 110c receive mutually different sets of data object parts. Further, each of the at least the first data object part and the second object part can be further modified on an individual basis; some can be transferred as-is, some encrypted, some anonymized or modified in some other fashion.

There may be different ways to enabling transfer of the data object to the second network domain 110b, 110c, as in step S112. Different embodiments relating thereto will now be described in turn.

According to a first embodiment the data objects is transferred and hence the first data controller 200a is configured to perform step S112a to enabling transfer of the data object as part of step S112:

S112a: The first data controller 200a transfers the data object to the second network domain 110b, 110c.

According to a second embodiment the data objects is prevented from being transferred and hence the first data controller 200a is configured to perform step S112b to enabling transfer of the data object as part of step S112:

S112b: The first data controller 200a prevents transfer of the data object to the second network domain 110b, 110c.

There may be different ways for the first data controller 200a to handle scenarios where a data object that is prevented from being transferred to the second network domain 110b, 110cstill is transferred to, or otherwise made available to, the second network domain 110b, 110c. According to an embodiment the first data controller 200a is configured to issue a breach notification if transfer of the data object is not allowed by performing steps S114 and S116:

S114: The first data controller 200a obtains notification from the second data controller 200b, 200c that transfer of the data object for which transfer of the data object to the second network domain 110b, 110c is prevented has occurred.

S116: The first data controller 200a issues a message in response to having obtained the notification.

Reference is now made to FIG. 7 illustrating a method for handling transfer of a data object between network domains 110a, 110b, 110c as performed by the data controller 200b, 200c of the second network domain 110b, 110c according to an embodiment. The data controller 200b, 200c will therefore be denoted a second data controller 200b, 200c (whereas the data controller 200a of the first network domain 110a will be denoted a first data controller 200a).

As disclosed above with reference to step S112a the first data controller 200a in an embodiment transfers the data object to the second network domain 110b, 110c. It is assumed that the second data controller 200b, 200c obtains the transferred data object and hence is configured to perform step S204:

S204: The second data controller 200b, 200c obtains the data object from the first data controller 200a of the network domain 110a. As disclosed above, the data object and the identifier are provided with a cryptographic integrity signature of the first data controller 200a.

Examples of how to provide the cryptographic integrity signature have been provided above. Thus, according to an embodiment the cryptographic integrity signature is based on integrity protection or a block chain technology such as a keyless signature infrastructure (KSI).

The second data controller 200b, 200c needs to know what kind of handling of the data object is allowed and is therefore configured to perform step S206:

S206: The second data controller 200b, 200c obtains an identifier identifying allowable handling of the data object in the second network domain 110b, 110c.

There could be different ways for the second data controller 200b, 200c to obtain the identifier identifying allowable handling of the data object in the second network domain 110b, 110c. According to a first embodiment the identifier is obtained from a local rule base in the second network domain 110b, 110c. One example of such a local rule base is the PIP module. In turn the PIP module of the second data controller 200b, 200c may retrieve the identifier from the central repository 130. According to a second embodiment the identifier is obtained from the first data controller 200a. In the latter case the identifier can be provided together with the data object and be provided with the cryptographic integrity signature of the first data controller 200a. In a case where the identifier is obtained from both the local rule base and the first data controller 200a, the handling as defined by the local rule base takes precedence.

Reference is now made to FIG. 8 illustrating methods for handling transfer of a data object between network domains 110a, 110b, 110c as performed by the data controller 200b, 200c of the second network domain 110b, 110c according to further embodiments. Steps S204 and S206 are performed as with reference to FIG. 7 and a repeated description thereof is therefore omitted.

As disclosed above, one way for the first data controller 200a to obtain the request in step S102 is to obtain the request from the second data controller 200b, 200c. Hence, according to an embodiment the second data controller 200b, 200c is configured to perform step S202:

S202: The second data controller 200b, 200c provides a request to the first data controller 200a for transmission of the data object to the second network domain 110b, 110c.

There can be different types of allowable handling of the data object in the second network domain 110b, 110c. According to an embodiment the allowable handling comprises preventing transfer of the data object to the second network domain 110b, 110c, allowing transfer of the data object to the second network domain 110b, 110c, preventing modification of the data object in the second network domain 110b, 110c transfer, allowing modification of the data object in the second network domain 110b, 110c, or any combination thereof.

The data object is provided with a cryptographic integrity signature. The second data controller 200b, 200c can therefore be configured to check that the integrity signature has not been tampered with by performing step S208:

S208: The second data controller 200b, 200c verifies the cryptographic integrity signature.

Upon having obtained the data object from the first data controller 200a, and optionally after also having verified the cryptographic integrity signature, the second data controller 200b, 200c can handle the data object as in step S210:

S210: The second data controller 200b, 200c handles the data object in the second network domain 110b, 110c according to the identifier (as obtained in step S206).

There can be different ways for the second data controller 200b, 200c to handle the data object in the second network domain 110b, 110c. According to an embodiment the second data controller 200b, 200c is configured to handle the data object in step S210 by performing step S210a:

S210a: The second data controller 200b, 200c modifies the data object according to the identifier.

There can be different ways for the second data controller 200b, 200c to modify the data object. According to an embodiment the second data controller 200b, 200c is configured to modify the data object in step S210a by performing any of steps S210aa, S210ab:

S210aa: The second data controller 200b, 200c combines at least a first data object part of the data object with a second object part of the data object into the data object. Hence, this embodiment corresponds to a scenario where the first data controller 200a has split the data object into the first data object part and the second object part before transfer of the data object to the second network domain 110b, 110c. As noted above, each part of the data object may be provided to a different receiver in the second network domain 110b, 110c and hence the second data controller 200b, 200c may comprise several receivers for receiving the different parts of the data object.

S210ab: The second data controller 200b, 200c decrypts the data object. Hence, this embodiment corresponds to a scenario where the first data controller 200a has encrypted the data object before transfer of the data object to the second network domain 110b, 110c.

Further, in a case the data object has been pseudonymized, the second data controller 200b, 200c could be configured to de-pseudonymize the data object.

Modification may involve discarding the data object if data transfer of the data object to the second network domain 110b, 110c is not allowed. According to an embodiment the second data controller 200b, 200c is therefore configured to handle the data object in step S210 by performing step S210b:

S210b: The second data controller 200b, 200c discards the data object when, according to the allowable handling, transfer of the data object to the second network domain 110b, 110c is to be prevented.

There can be different ways for the second data controller 200b, 200c to act once having discarded the data object. For example, the second data controller 200b, 200c could inform the first data controller 200a. According to an embodiment the second data controller 200b, 200c is thus configured to handle the data object in step S210 by performing step S210c:

S210c: The second data controller 200b, 200c notifies the first data controller 200a that transfer of the data object for which transfer of the data object to the second network domain 110b, 110c is to be prevented has occurred.

A first particular embodiment for handling transfer of a data object between network domains 110a, 110b as performed by the data controller 200a, of the first network domain 110a and the data controller 200b of the second network domain 110b based on at least some of the above disclosed embodiments will now be disclosed in detail.

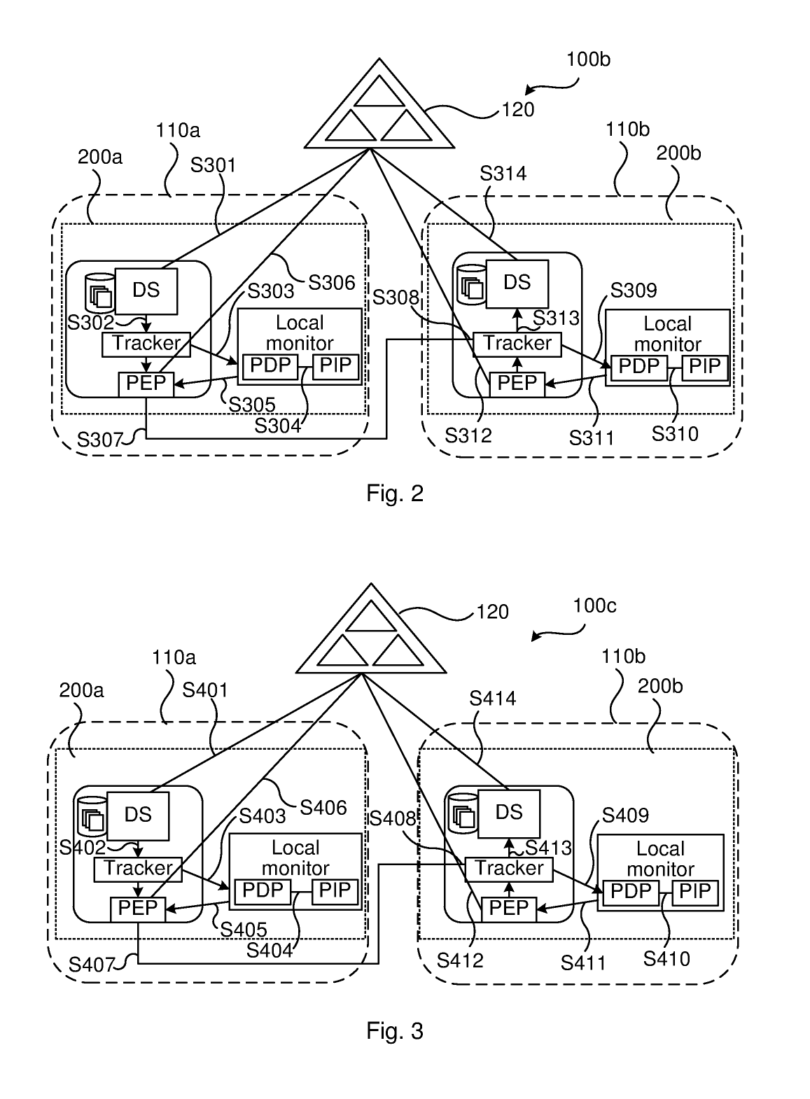

Particular reference is here made to FIG. 2. FIG. 2 is a schematic diagram illustrating a communications network 100b being a part of the communications network 100a of FIG. 1. A thus repeated description of the elements of the communications network 100b is therefore omitted.

This first particular embodiment relates to a scenario where transfer of the data object from network domain 110a and network domain 110b is allowed.

S301: The first data controller 200a reads the data object from a local database and verifies the integrity of the data object by a digital signature module using KSI in the first data controller 200a.

S302: The first data controller 200a provides the data object to a tracker module in the first data controller 200a from the database.

S303: The tracker module in the first data controller 200a indicates to a local monitor module in the first data controller 200a from where (i.e. from which network domain) the data object is coming and to where (i.e. to which network domain) the data object is to be transferred. The tracker module associates a location tag to the data object.

S304: A Policy Decision Point module in the first data controller 200a reads from a Policy Information Point module (acting as a local rule base) in the first data controller 200a for allowed/disallowed handling of the data object. The Policy Decision Point module analyses whether the data object is to be transferred between network domains with or without modification, then passes the information to an Enforcer module in the first data controller 200a.

S305: The Enforcer module inserts, based on information passed from the Policy Decision Point module, a domain signature by binding the domain signature to the location tag of the object, and if transfer of the data object is allowed with modification, the Enforcer module modifies the data object accordingly.

S306: The Policy Decision Point module integrity protects the domain signature by binding a cryptographic integrity signature to the data object by binding the cryptographic integrity signature to the domain signature.

S307: The first data controller 200a provides the data object to the second network domain 110b.

S308: A Tracker module in the second data controller 200b obtains the data object and the domain signature.

S309: The Tracker module passes the domain signature to a local monitor module in the second data controller 200b to obtain information of from where (i.e. from which network domain) the data object is coming and to where (i.e. to which network domain) the data object is to be transferred.

S310: A Policy Decision Point module in the second data controller 200b reads from a Policy Information Point module (acting as a local rule base) in the second data controller 200b for allowed/disallowed handling of the data object. The Policy Decision Point module analyses whether the data object is transferred between network domains with or without modification, then passes the information to an Enforcer module in the second data controller 200b.

S311: The Enforcer module acts based on the instructions received from the Policy Decision Point module in the second data controller 200b. If transfer of the data object is allowed with modification, the Enforcer module modifies the data object accordingly.

S312: The Enforcer module verifies the integrity of the domain signature by verifying the cryptographic integrity signature.

S313: The Tracker module passes the data object together with the cryptographic integrity signature to a digital signature module in the second data controller 200b.

S314: The digital signature module verifies the integrity of the data object before storing the data object in a local database.

A second particular embodiment for handling transfer of a data object between network domains 110a, 110b as performed by the data controller 200a, of the first network domain 110a and the data controller 200b of the second network domain 110b based on at least some of the above disclosed embodiments will now be disclosed in detail.

Particular reference is here made to FIG. 3. FIG. 3 is a schematic diagram illustrating a communications network 100c being a part of the communications network 100a of FIG. 1. A thus repeated description of the elements of the communications network 100c is therefore omitted.

This second particular embodiment relates to a scenario where transfer of the data object, including modifications of the data object, from network domain 110a and network domain 110b is allowed.

S401: The first data controller 200a reads the data object from a local database and verifies the integrity of the data object by a digital signature module using KSI in the first data controller 200a.

S402: The first data controller 200a provides the data object to a tracker module in the first data controller 200a from the database.

S403: The tracker module in the first data controller 200a indicates to a local monitor module in the first data controller 200a from where (i.e. from which network domain) the data object is coming and to where (i.e. to which network domain) the data object is to be transferred. The tracker module associates a location tag to the data object.

S404: A Policy Decision Point module in the first data controller 200a reads from a Policy Information Point module (acting as a local rule base) in the first data controller 200a for allowed/disallowed handling of the data object. The Policy Decision Point module analyses whether the data object is to be transferred between network domains with or without modification, then passes the information to an Enforcer module in the first data controller 200a.

When the data object is allowed transfer with modification, the Policy Information Point module provides rules how the data object is allowed to be modified. One example concerns whether the data object shall be split into smaller data objects before transfer. One example concerns which of the smaller data objects that are allowed transfer between network domains, and which smaller data objects that are not allowed transfer between network domains. One example concerns whether the data object, e.g. privacy related data objects, shall be anonymized or pseudonymised before transfer. One example concerns whether the data object shall be encrypted before transfer to another network domain.

S405: The Enforcer module inserts, based on information passed from the Policy Decision Point module, a domain signature by binding the domain signature to the location tag of the object, and if transfer of the data object is allowed with modification, the Enforcer module modifies the data object accordingly.

S406: The Policy Decision Point module integrity protects the domain signature by binding a cryptographic integrity signature to the data object by binding the cryptographic integrity signature to the domain signature.

S407: The first data controller 200a provides the data object to the second network domain 110b.

S408: A Tracker module in the second data controller 200b obtains the data object and the domain signature.

S409: The Tracker module passes the domain signature to a local monitor module in the second data controller 200b to obtain information of from where (i.e. from which network domain) the data object is coming and to where (i.e. to which network domain) the data object is to be transferred.

S410: A Policy Decision Point module in the second data controller 200b reads from a Policy Information Point module (acting as a local rule base) in the second data controller 200b for allowed/disallowed handling of the data object. The Policy Decision Point module analyses whether the data object is transferred between network domains with or without modification, then passes the information to an Enforcer module in the second data controller 200b.

When the data object has been allowed transfer with modification, the Policy Information Point module provides rules how the data object is allowed to be modified. One example concerns whether the data object has been split into smaller data objects before transfer and thus that the smaller objects are to be combined. One example concerns whether the data object has been encrypted before transfer to the network domain and thus that the data objects is to be decrypted. If the data object is supposed to be encrypted but is obtained by the second data controller 200b without being encrypted, the second data controller 200b may discard the data object.

S411: The Enforcer module acts based on the instructions received from the Policy Decision Point module in the second data controller 200b. If transfer of the data object is allowed with modification, the Enforcer module modifies the data object accordingly.

S412: The Enforcer module verifies the integrity of the domain signature by verifying the cryptographic integrity signature.

S413: The Tracker module passes the data object together with the cryptographic integrity signature to a digital signature module in the second data controller 200b.

S414: The digital signature module verifies the integrity of the data object before storing the data object in a local database.

A third particular embodiment for handling transfer of a data object between network domains 110a, 110c as performed by the data controller 200a, of the first network domain 110a and the data controller 200c of the second network domain 110c based on at least some of the above disclosed embodiments will now be disclosed in detail.

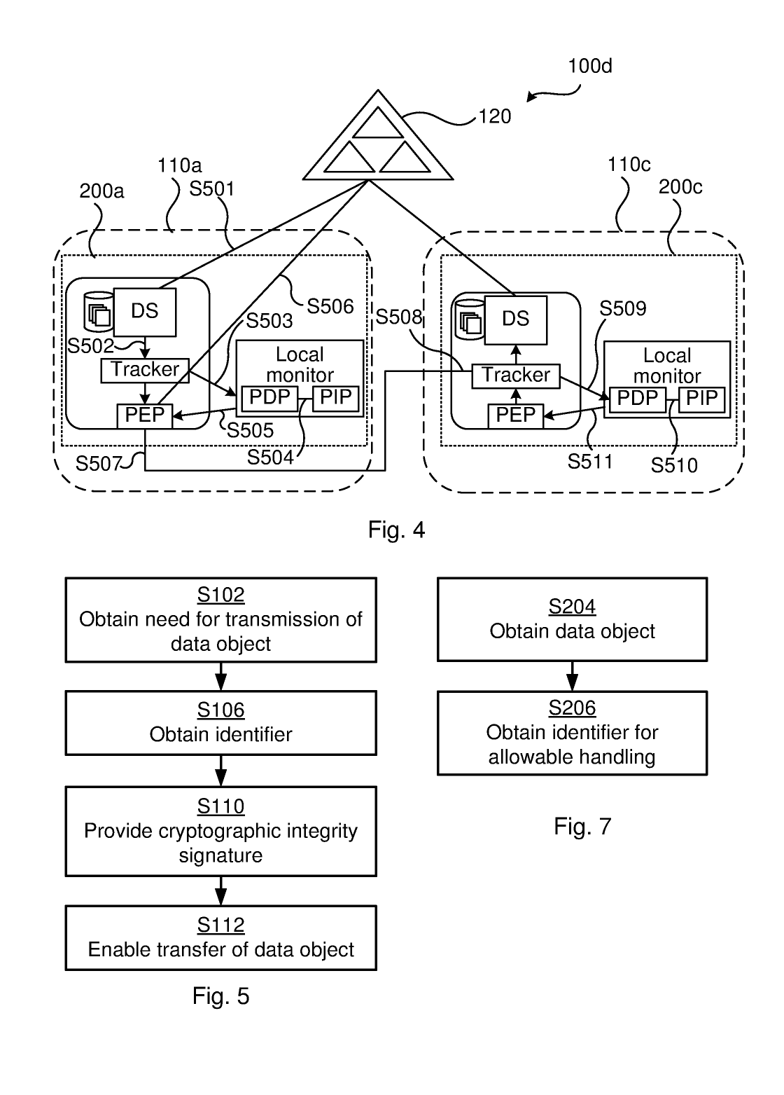

Particular reference is here made to FIG. 4. FIG. 4 is a schematic diagram illustrating a communications network 100d being a part of the communications network 100a of FIG. 1. A thus repeated description of the elements of the communications network 100d is therefore omitted.

This third particular embodiment relates to a scenario where transfer of the data object from network domain 110a and network domain 110c is not allowed.

S501: The first data controller 200a reads the data object from a local database and verifies the integrity of the data object by a digital signature module using KSI in the first data controller 200a.

S502: The first data controller 200a provides the data object to a tracker module in the first data controller 200a from the database.

S503: The tracker module in the first data controller 200a indicates to a local monitor module in the first data controller 200a from where (i.e. from which network domain) the data object is coming and to where (i.e. to which network domain) the data object is to be transferred. The tracker module associates a location tag to the data object.

S504: A Policy Decision Point module in the first data controller 200a reads from a Policy Information Point module (acting as a local rule base) in the first data controller 200a for allowed/disallowed handling of the data object. The Policy Decision Point module analyses whether the data object is to be transferred between network domains with or without modification, then passes the information to an Enforcer module in the first data controller 200a.

S505: If transfer of the data object is not allowed the Enforcer module discards the data object transfer and generates a data discarded message.

It is hereinafter in steps S506-S511 assumed that the data object still is transferred to the second network domain 110c, although such transfer should be prevented. Steps S506-S511 are provided for completeness of this description and to describe the operations performed by the second data controller 200c when obtaining a data object not allowed to be transferred to the network domain 110c of the second data controller 200c. In more detail, steps S508-S511 as performed by the second data controller 200c can be performed in order to detect attempts of unauthorized transfer of the data object to the second network domain 110c.

S506: The Policy Decision Point module integrity protects the domain signature by binding a cryptographic integrity signature to the data object.

S507: The first data controller 200a provides the data object to the second network domain 110c.

S508: A Tracker module in the second data controller 200b obtains the data object and the domain signature.

S509: The Tracker module passes the domain signature to a local monitor module in the second data controller 200c to obtain information of from where (i.e. from which network domain) the data object is coming and to where (i.e. to which network domain) the data object is to be transferred.

S510: A Policy Decision Point module in the second data controller 200b reads from a Policy Information Point module (acting as a local rule base) in the second data controller 200b for allowed/disallowed handling of the data object. The Policy Decision Point module analyses whether the data object is transferred between network domains with or without modification, then passes the information to an Enforcer module in the second data controller 200b.

S511: The Enforcer module acts based on the instructions received from the Policy Decision Point module in the second data controller 200b. If transfer of the data object is not allowed the Enforcer module discards the data object generates a data discarded message.

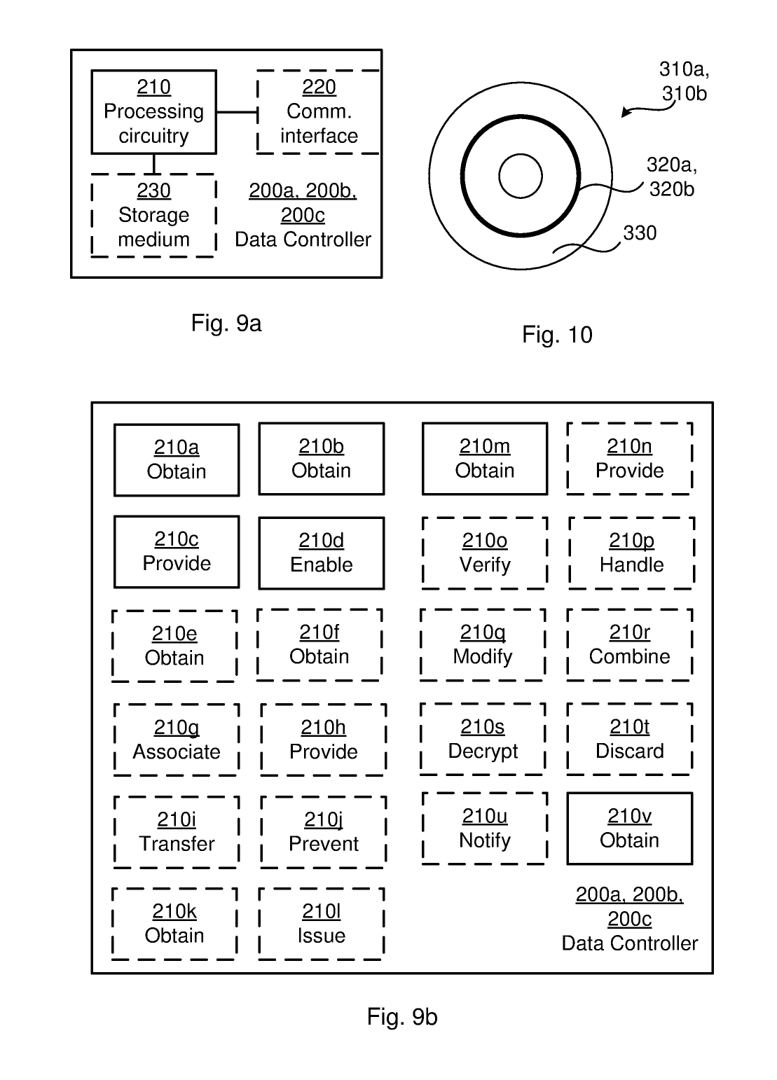

FIG. 9a schematically illustrates, in terms of a number of functional units, the components of a data controller 200a, 200b, 200c according to an embodiment. The data controller 200a, 200b, 200c is configured to selectively act as a data controller 200a of the first network domain 110a and as a data controller 200b, 200c of the second network domain 110b, 110c.

Processing circuitry 210 is provided using any combination of one or more of a suitable central processing unit (CPU), multiprocessor, microcontroller, digital signal processor (DSP), etc., capable of executing software instructions stored in a computer program product 310a, 310b (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the data controller 200a, 200b, 200c to perform a set of operations, or steps, S102-S210, as disclosed above. For example, the storage medium 230 may store the set of operations, and the processing circuitry 210 may be configured to retrieve the set of operations from the storage medium 230 to cause the data controller 200a, 200b, 200c to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The data controller 200a, 200b, 200c may further comprise a communications interface 220 for communications at least with another data controller 200a, 200b, 200c. As such the communications interface 220 may comprise one or more transmitters and receivers, comprising analogue and digital components and a suitable number of antennas for wireless communications and ports for wireline communications.

The processing circuitry 210 controls the general operation of the data controller 200a, 200b, 200c e.g. by sending data and control signals to the communications interface 220 and the storage medium 230, by receiving data and reports from the communications interface 220, and by retrieving data and instructions from the storage medium 230. Other components, as well as the related functionality, of the data controller 200a, 200b, 200c are omitted in order not to obscure the concepts presented herein.

FIG. 9b schematically illustrates, in terms of a number of functional modules, the components of a data controller 200a, 200b, 200c according to an embodiment.

A data controller 200a of the first network domain 110a comprises a number of functional modules; an obtain module 210a configured to perform step S102, an obtain module 210b configured to perform step S106, a provide module 210c configured to perform step S110, and an enable module 210d configured to perform step S112. The data controller 200a of the first network domain 110a may further comprise a number of optional functional modules, such as any of an obtain module 210e configured to perform step S102a, an obtain module 210f configured to perform step S102b, an associate module 210g configured to perform step S104, a provide module 210h configured to perform step S108, a transfer module 210i configured to perform step S112a, a prevent module 210j configured to perform step S112b, an obtain module 210k configured to perform step S114, and an issue module 2101 configured to perform step S116.

A data controller 200b, 200c of the second network domain 110b, 110c comprises an obtain module 210m configured to perform step S204, and an obtain module 210v configured to perform step S206. The data controller 200b, 200c of the second network domain 110b, 110c may further comprise a number of optional functional modules, such as any of a provide module 210n configured to perform step S202, a verify module 210o configured to perform step S208, a handle module 210p configured to perform step S210, a modify module 210q configured to perform step S210a, a combine module 210r configured to perform step S210aa, a decrypt module 210s configured to perform step S210ab, a discard module 210t configured to perform step S210b, and a notify module 210u configured to perform step S210c.

In general terms, each functional module 210a-210u may be implemented in hardware or in software. Preferably, one or more or all functional modules 210a-210u may be implemented by the processing circuitry 210, possibly in cooperation with functional units 220 and/or 230. The processing circuitry 210 may thus be arranged to from the storage medium 230 fetch instructions as provided by a functional module 210a-210u and to execute these instructions, thereby performing any steps as disclosed herein.

The data controller 200a, 200b, 200c may be provided as a standalone device or as a part of at least one further device. Alternatively, functionality of the data controller 200a, 200b, 200c may be distributed between at least two devices, or nodes. Thus, a first portion of the instructions performed by the data controller 200a, 200b, 200c may be executed in a first device, and a second portion of the of the instructions performed by the data controller 200a, 200b, 200c may be executed in a second device; the herein disclosed embodiments are not limited to any particular number of devices on which the instructions performed by the data controller 200a, 200b, 200c may be executed. Hence, the methods according to the herein disclosed embodiments are suitable to be performed by a data controller 200a, 200b, 200c residing in a cloud computational environment. Therefore, although a single processing circuitry 210 is illustrated in FIG. 9a the processing circuitry 210 may be distributed among a plurality of devices, or nodes. The same applies to the functional modules 210a-210u of FIG. 9b and the computer programs 320a, 320b of FIG. 10 (see below).

FIG. 10 shows one example of a computer program product 310a, 310b comprising computer readable means 330. On this computer readable means 330, a computer program 320a can be stored, which computer program 320a can cause the processing circuitry 210 and thereto operatively coupled entities and devices, such as the communications interface 220 and the storage medium 230, to execute methods according to embodiments described herein. The computer program 320a and/or computer program product 310a may thus provide means for performing any steps of the data controller 200a of the first network domain 110a as herein disclosed. On this computer readable means 330, a computer program 320b can be stored, which computer program 320b can cause the processing circuitry 310 and thereto operatively coupled entities and devices, such as the communications interface 320 and the storage medium 330, to execute methods according to embodiments described herein. The computer program 320b and/or computer program product 310b may thus provide means for performing any steps of the data controller 200b, 200c of the second network domain 110b, 110c as herein disclosed.

In the example of FIG. 10, the computer program product 310a, 310b is illustrated as an optical disc, such as a CD (compact disc) or a DVD (digital versatile disc) or a Blu-Ray disc. The computer program product 310a, 310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320a, 320b is here schematically shown as a track on the depicted optical disk, the computer program 320a, 320b can be stored in any way which is suitable for the computer program product 310a, 310b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for handling transfer of a data object between network domains, the method being performed by a first data controller of a first network domain, the method comprising:
obtaining a request for transmission of the data object to a second data controller of a second network domain;
obtaining an identifier identifying allowable transfer of the data object between the first network domain and the second network domain;
providing a cryptographic integrity signature to the data object; and
enabling transfer of the data object to the second network domain according to the identifier.

2. The method according to claim 1, wherein obtaining said request comprises:
obtaining a request from the second data controller for transmission of the data object to the second network domain.

3. The method according to claim 1, wherein obtaining said request comprises:
obtaining a request from a local send function of the first data controller for transmission of the data object to the second network domain.

4. The method according to claim 1, further comprising:
associating the data object with a location tag, the location tag identifying the first network domain; and
providing, based on the identifier, a cryptographic domain signature that binds the location tag to the data object.

5. The method according to claim 1, wherein said allowable transfer comprises at least one of: preventing transfer of the data object to the second network domain, allowing transfer of the data object to the second network domain, preventing modification of the data object in the second network domain transfer, allowing modification of the data object in the second network domain, and requiring modification of the data object in the first network domain prior to transfer of the data object to the second network domain.

6. (canceled)

7. The method according to claim 5, wherein said allowable transfer requires the data object to be modified prior to transfer of the data object to the second network domain.

8. (canceled)

9. The method according to claim 1, wherein said enabling handling comprises:
transferring the data object to the second network domain; or
preventing transfer of the data object to the second network domain.

10. The method according to claim 1, further comprising:
obtaining notification from the second data controller that transfer of the data object for which transfer of the data object to the second network domain is prevented has occurred; and
issuing a message in response to having obtained the notification.

11. A method for handling transfer of a data object between network domains, the method being performed by a second data controller of a second network domain, the method comprising:
obtaining the data object from a first data controller of a first network domain, wherein the data object is provided with a cryptographic integrity signature of the first data controller; and
obtaining an identifier identifying allowable handling of the data object in the second network domain.

12. The method according to claim 11, further comprising:
providing a request to the first data controller for transmission of the data object to the second network domain.

13. The method according to claim 11, wherein said allowable handling comprises at least one of: preventing transfer of the data object to the second network domain, allowing transfer of the data object to the second network domain, preventing modification of the data object in the second network domain transfer, and allowing modification of the data object in the second network domain.

14. The method according to claim 11, further comprising:
verifying the cryptographic integrity signature.

15. The method according to claim 11, further comprising:
handling the data object in the second network domain according to the identifier.

16. The method according to claim 15, wherein handling the data object comprises:
modifying the data object according to the identifier.

17. The method according to claim 16, wherein modifying the data object comprises at least one of:
combining at least a first data object part of the data object with a second object part of the data object into the data object, and
decrypting the data object.

18. The method according to claim 15, wherein handling the data object comprises:
discarding the data object when, according to said allowable handling, transfer of the data object to the second network domain is prevented.

19. The method according to claim 18, further comprising:
notifying the first data controller that transfer of the data object for which transfer of the data object to the second network domain is prevented has occurred.

20. (canceled)

21. The method according to claim 11, wherein the cryptographic integrity signature is based on a keyless signature infrastructure, KSI.

22. (canceled)

23. A data controller of a first network domain for handling transfer of a data object between network domains, the data controller comprising:
processing circuitry; and
a computer program product storing instructions that, when executed by the processing circuitry, causes the data controller to:
obtain a request for transmission of the data object to another data controller of a second network domain;
obtain an identifier identifying allowable transfer of the data object between the first network domain and the second network domain;
provide a cryptographic integrity signature to the data object; and
enable transfer of the data object to the second network domain according to the identifier.

24. (canceled)

25. (canceled)

26. A data controller of a second network domain for handling transfer of a data object between network domains, the data controller comprising:
processing circuitry; and
a computer program product storing instructions that, when executed by the processing circuitry, causes the data controller to:
obtain the data object from a first data controller of a first network domain, wherein the data object is provided with a cryptographic integrity signature of the first data controller; and
obtain an identifier identifying allowable handling of the data object in the second network domain.

27-30. (canceled)
